(19) United States
(12) Patent Application Publication
(10) Pub. No.: US 2008/0015310 A1
(43) Pub. Date: Jan. 17, 2008

(54) Surface Support Method

(76) Inventor: Jiangdong Tong, Ontano (CA)

Correspondence Address: 3M INNOVATIVE PROPERTIES COMPANY, PO BOX 33427, ST. PAUL, MN, 55133-3427, US

(21) Appl. No.: 11/574,935

(22) PCT Filed: Sep. 19, 2005
(86) PCT No.: PCT/US05/33262

§ 371 Date: Mar. 8, 2007

Related U.S. Application Data
(60) Provisional application No. 60/611,321, filed on Sep. 20, 2004.

(51) Int. Cl. C04B 41/48; C08G 18/10; E21D 11/10

(52) U.S. Cl. 524/589; 525/127; 525/452

(57) ABSTRACT

A method comprises providing a liner to at least a portion of at least one surface, the liner comprising the product of reaction of (a) at least one prepolymer bearing isocyanate groups; (b) at least one polymer bearing isocyanate-reactive groups; and (c) at least one polymerizable reactive diluent; wherein the surface comprises at least one inorganic mineral other than a metal or a glass, with the proviso that the surface is a surface other than a trafficable surface.

### STATEMENT OF PRIORITY

This application claims the priority of U.S. Provisional Application No. 60/611,321 filed Sep. 20, 2004, the contents of which are hereby incorporated by reference.

### FIELD

The invention relates to a method for providing support to surfaces such as, for example, rock surfaces. The invention also relates to an elastomeric polymeric film that can be used as a load-bearable coating (for example, to assist in protecting from rock bursts in a mine) and to kits for preparing such a film.

### BACKGROUND

Underground mining requires support of the roof and walls of a mine to prevent injury due to rock bursts. A number of materials have been used for this purpose, including shotcrete, wire mesh, and sprayable liner compositions. Both shotcrete and wire mesh are somewhat difficult to handle and apply in underground mines, more particularly in deep mining applications. The application of shotcrete/gunite is labor intensive, and the resulting linings are generally brittle, lacking in significant tensile strength and toughness, and prone to fracturing upon flexing of the rock during mine blasting. In addition, shotcrete/gunite generally develops its desired tensile strength of about 1 MPa only slowly. The sprayable liners that develop strength quickly are often toxic during spray application, whereas liners that have low toxicity during spray application are often not tough enough and generally require more than four hours (at ambient temperature without application of heat) to develop the minimum strength desired to be useful in the mining environment.

### SUMMARY

Thus, we recognize that methods for providing a surface with a tough, flexible, easy-to-apply, and/or quick strength-developable (at ambient temperature) liner system are needed for mining applications, as well as for containment of structural debris resulting from, for example, commercial demolition of a building structure or destruction of a building structure by natural causes or by terrorist activity. The present invention provides such a method, which comprises providing a liner to at least a portion of at least one surface, the liner comprising the product of reaction of
(a) at least one prepolymer bearing isocyanate groups;
(b) at least one polymer bearing isocyanate-reactive groups; and
(c) at least one polymerizable reactive diluent;
   wherein the surface comprises at least one inorganic mineral other than a metal or a glass, with the proviso that the surface is a surface other than a trafficable surface (that is, a surface other than a traffic-bearing surface, for example, such as a highway, bicycle path, or sidewalk used for vehicular or pedestrian traffic). Preferably, the surface comprises at least one material selected from the group consisting of rock, stone, concrete, brick, stucco, and the like, and combinations thereof.

The liner can have a tensile strength, elongation at break, and thickness sufficient to provide support to exposed surfaces in an excavation. Thus, the liner preferably exhibits a 4-hour Tensile Strength of at least about 1 MPa and/or an elongation at break of at least about 10 percent and/or a thickness of at least about 0.5 mm. The reactive diluent is preferably a free-radically polymerizable monomer (more preferably, an acryloyl- or methacryloyl-functional monomer).

As used herein, the term “liner” means a load-bearable coating that can be applied to a surface (for example, the surfaces of mining cavities, concrete or masonry structures such as buildings and parking garages, highway overpasses and underpasses (for example, bridges and tunnels), and roadsides, for example, to provide support and/or to contain loose or falling debris); and the term “4-hour Tensile Strength” means a tensile strength value that is measured 4 hours after mixing components (a), (b), and (c) according to ASTM D-638-97 (Standard Test Method for Tensile Properties of Plastics, published by American Society for Testing and Materials, West Conshohocken, Pa.) modified by utilizing a crosshead speed of 200 mm per minute, a sample width of 0.635 cm (0.25 inch), and a gauge separation of 5.08 cm (2 inches).

The method of the invention provides a surface with a liner that can exhibit surprising ultimate load-bearing capability (upon complete cure) and, prior to complete cure, generally develops sufficient strength to be useful in a load-bearing capacity (for example in a mining environment) within about 4 hours. A wide range of starting liner components can be utilized in the method and can be easily applied to a surface by spraying (even at low temperatures), yet the resulting composition can cure to provide a tough, flexible, relatively thick coating. In addition, starting liner components of sufficiently low hydrophilicity can be selected so as to provide a liner that is relatively water-resistant and stable to hydrolysis.

In another aspect, the invention provides a liner comprising the product of reaction of
(a) at least one prepolymer bearing isocyanate groups;
(b) at least one polymer bearing isocyanate-reactive groups;
(c) at least one polymerizable reactive diluent; and
(d) expandable graphite.

In yet another aspect, the invention also provides kits for producing a liner. A first kit comprises
(a) a first composition comprising
   (1) at least one prepolymer bearing isocyanate groups and
   (2) at least one polymerizable reactive diluent that contains essentially no isocyanate-reactive groups (that is, sufficiently few isocyanate-reactive groups that a liner prepared from the kit exhibits a 4-hour Tensile Strength of at least about 1 MPa); and
(b) a second composition comprising at least one polymer bearing isocyanate-reactive groups, which, when combined with the first composition, reacts to form a material suitable for use as a liner;
wherein the kit further comprises expandable graphite.
   A second kit comprises
(a) a first composition comprising
   (1) at least one polymer bearing isocyanate-reactive groups and
   (2) at least one polymerizable reactive diluent that contains essentially no isocyanate groups; and
(b) a second composition comprising at least one prepolymer bearing isocyanate groups, which, when combined with the first composition, reacts to form a material suitable for use as a liner;
wherein the kit further comprises expandable graphite.

### DETAILED DESCRIPTION

Prepolymers Bearing Isocyanate Groups

Isocyanate group-bearing prepolymers suitable for use in the method of the invention include those that are capable of reacting with the isocyanate-reactive groups of component (b) and/or with component (c). Such prepolymers are well-known in the art. Generally, the preparation of such prepolymers involves the reaction of a polyfunctional active hydrogen-containing compound with a diisocyanate or other polyisocyanate, using an excess of the isocyanate to yield an isocyanate-terminated prepolymer product. An extensive description of some of the useful techniques for preparing suitable isocyanate prepolymers can be found in the text by J. H. Saunders and K. C. Frisch entitled Polyurethanes: Chemistry and Technology, Part II, pages 8-49 and cited references, Interscience Publishers, New York (1964). Other known preparative techniques can also be employed. Preferably, the prepolymers have an average isocyanate functionality of at least about 2 (more preferably, about 2 to about 5; most preferably, about 2 to about 3).

Suitable polyfunctional active hydrogen-containing compounds for use in preparing the prepolymers include polyols, polyamines, polythiols, and the like, and mixtures thereof. Polyols are generally preferred. Preferably, the compounds exhibit relatively low hydrophilicity.

Useful polyols include polyester, polyether, polycarbonate, and polyether polyester polyols having an average hydroxyl functionality of at least about 2 (preferably, about 2 to about 3) and a molecular weight greater than about 500 (preferably, in the range of about 500 or 1,000 to about 5,000 or 10,000), so as to provide prepolymer having a molecular weight in the range of about 1,000 to about 10,000. Also useful are acrylic polyols of such functionalities having a degree of polymerization of about 3 to about 50 and a molecular weight of about 360 to about 6000, as well as low molecular weight glycols (for example, having a molecular weight in the range of about 62 to about 250).

Preferred polyols have molecular weights that enable the preparation of liquid prepolymers. Polycarbonates, polyethers, and polyesters are generally preferred, with polyethers being more preferred. Most preferred are polyethers that exhibit relatively low hydrophilicity (for example, polyethers having fewer than half (more preferably, fewer than one-third; most preferably, fewer than one-fourth) of the total number of ether units being ethyleneoxy units).

Suitable polyester polyols include those formed from diacids (or their monoester, diester, or anhydride counterparts) and diols or triols. Useful diacids include saturated C₄-C₁₂ aliphatic acids (including branched, unbranched, or cyclic materials) and/or C₈-C₁₅ aromatic acids. Examples of suitable aliphatic acids include, for example, succinic, glutaric, adipic, castor fatty acid, pimelic, suberic, azelaic, sebacic, 1,12-dodecanedioic, 1,4- cyclohexanedicarboxylic, 2-methylpentanedioic acids, and the like, and mixtures thereof. Examples of suitable aromatic acids include, for example, terephthalic, isophthalic, phthalic, 4,4′-benzophenone dicarboxylic, 4,4′-diphenylamine dicarboxylic acids, and the like, and mixtures thereof. Useful diols include C₂-C₁₂ branched, unbranched, or cyclic aliphatic diols. Examples of suitable diols and triols include, for example, ethylene glycol, glycerine, neopentyl glycol, 1,3-propylene glycol, trimethylol propane, 1,2-propylene glycol, 1,4-butanediol, 1,3-butanediol, hexanediols, 2-methyl-2,4-pentanediol, cyclohexane-1,4-dimethanol, 1,12-dodecanediol, and the like, and mixtures thereof.

Suitable polyether polyols include polyoxy-C₂-C₆-alkylene polyols (having branched or unbranched alkylene groups). Examples of suitable polyether diols include, for example, polyethylene oxide, poly(1,2- and 1,3-propyleneoxide), poly(1,2-butyleneoxide), random or block copolymers of ethylene oxide and 1,2-propylene oxide, polytetramethylene glycols, propylene glycol, neopentyl glycol, hexanediol, butanediol, and the like, and mixtures thereof.

Suitable polyester polyether polyols can be made from polyethers having a molecular weight of about 200 to about 2000 and a functionality of about 2 to about 3, with acids, for example, such as adipic acid, phthalic acid, isophthalic acid, or terephthalic acid.

Suitable polycarbonate polyols include aliphatic polycarbonate diols and the like, and mixtures thereof.

Suitable acrylic polyols include polyols based on monoethylenically unsaturated monomers such as monoethylenically unsaturated carboxylic acids and esters thereof, styrene, vinyl acetate, vinyl trimethoxysilane, acrylamides, and the like, and mixtures thereof. Useful monomers include but are not limited to methyl acrylate, butyl acrylate, ethyl acrylate, 2-ethylhexyl acrylate, hydroxybutyl acrylate, hydroxyethyl acrylate, glycidyl acrylate, lauryl acrylate, acrylic acid, and the like, and mixtures thereof. The polymers can be homopolymers or copolymers. The copolymers can also contain a significant number of units derived from methacrylate monomers (for example, methyl methacrylate, butyl methacrylate, hydroxyethyl methacrylate, lauryl methacrylate, glycidyl methacrylate, methacrylic acid, and the like, and mixtures thereof). Preferred acrylic polyols include hydroxy-functional oligomers prepared by the process described in U.S. Pat. No. 5,710,227 (Freeman et al.) and EP Patent No.1 044 991 (Rohm and Haas Company), wherein the oligomers have a degree of polymerization (DP) of about 3 to about 50 and a molecular weight of about 360 to about 6000 (preferably, a DP of about 5 to about 20 and a molecular weight of about 600 to about 2400).

Polyisocyanates that can be used to prepare the prepolymers having isocyanate groups include aliphatic, alicyclic, and aromatic polyisocyanates, and mixtures and combinations thereof. Useful polyisocyanates (or isocyanate monomers) have an average isocyanate functionality of at least about 2 (preferably, about 2 to about 5; more preferably, about 2).

Preferably, the polyisocyanates are aromatic polyisocyanates (for example, due to greater reactivity rate). One of the most useful polyisocyanate compounds that can be used is tolylene diisocyanate (TDI), particularly as a blend of 80 weight percent of tolylene-2,4-diisocyanate and 20 weight percent of tolylene-2,6-diisocyanate. A 65:35 blend of the 2,4- and 2,6-isomers can also be used. These polyisocyanates are commercially available under the trademark HYLENE, as NACCONATE 80, and as MONDUR TD-80. The tolylene diisocyanates can also be used as a mixture with methylene diphenyl diisocyanate.

Other polyisocyanate compounds that can be used (alone or in combination) include other isomers of tolylene diisocyanate; hexamethylene diisocyanate (HDI) including, for example, the 1,6 isomer; xylene diisocyanate (XDI); methylene diphenyl diisocyanate (MDI) including, for example, diphenylmethane-4,4′-diisocyanate; m- or p-phenylene diisocyanate; isophorone diisocyanate (IPDI); 1,5-naphthalene diisocyanate; tetramethylene diisocyanate; 1,4-cyclohexane diisocyanate; hexahydrotolylene diisocyanate; 1-methoxy-2,4-phenylene diisocyanate; 2,4-diphenylmethane diisocyanate; 4,4′-biphenylene diisocyanate; 3,3′-dimethoxy-4,4′-biphenyl diisocyanate; 3,3′-dimethyl-4,4′-biphenyl diisocyanate; 3,3′-dimethyl-4,4′-diphenylmethane diisocyanate; and the like; and mixtures thereof. Polymeric polyisocyanates can also be used (for example, polymethylene polyphenyl polyisocyanates, such as those sold under the trademarks MONDUR MRS and PAPI). A list of useful commercially available polyisocyanates can be found in Kirk-Othmer Encyclopedia of Chemical Technology, 2nd Ed., Vol. 12, pages 46-47, Interscience Publishers (1967).

Preferred isocyanates include tolylene diisocyanate (TDI), hexamethylene diisocyanate (HDI), methylene diphenyl isocyanate (MDI), xylene diisocyanate (XDI), and the like, and mixtures thereof.

As stated above, isocyanate-functional prepolymers can be formed by reacting a polyol and an excess of monomeric polyisocyanate. Useful prepolymers can have, for example, an isocyanate (NCO) content of about 11.5 percent by weight or less and an average NCO functionality of about 4 or less. The prepolymer is preferably a urethane-containing polymer bearing isocyanate groups.

The prepolymer bearing isocyanate groups can be prepared, for example, by reacting a polyisocyanate with a copolymer of polyoxyethylene-propylene polyol using an NCO/OH equivalent ratio of about 5:1 to about 1.05:1, preferably a ratio of about 2.0:1 to 2.5:1. The preparation of isocyanate-terminated prepolymers is described, for example, in U.S. Pat. No. 4,315,703 (Gasper) and U.S. Pat. No. 4,476,276 (Gasper) and references therein, the descriptions of which are incorporated herein by reference. Benzoyl chloride can be added during prepolymer preparation to avoid side reactions of polyisocyanate. Preferably, no solvent is used to dilute the prepolymer. However, a solvent can be used if necessary or desired.

Following prepolymer preparation, purification of the prepolymer is preferably carried out to remove unreacted monomeric polyisocyanate. This is preferably accomplished by quenching the unreacted monomeric polyisocyanate with a compound that is reactive to isocyanate groups, so that the prepolymer preferably contains less than about 0.7 weight percent (more preferably, less than about 0.5 weight percent) of unreacted monomeric polyisocyanate.

Unless the amount of unreacted monomeric polyisocyanate present in the mixture containing the prepolymer is lowered through a purification step or effectively reduced by, for example, quenching the isocyanate groups of the monomeric polyisocyanate, the presence of the monomeric polyisocyanate can result in toxicity (for example, during spraying of the liner composition). Also, it has been discovered that by removing or quenching the unreacted monomeric polyisocyanates, preferred liners of superior strength can be produced. Other advantages can include reduced toxicity and lowered heat generation.

The prepolymer can be purified from unreacted monomeric polyisocyanate by processes and/or methods using, for example, falling film evaporators, wiped film evaporators, distillation techniques, various solvents, molecular sieves, or organic reactive reagents such as benzyl alcohol. U.S. Pat. No. 4,061,662 (Marans et al.) describes the removal of unreacted tolylene diisocyanate (TDI) from an isocyanate prepolymer by contacting the prepolymer with molecular sieves. U.S. Pat. No. 3,248,372 (Bunge), U.S. Pat. No. 3,384,624 (Heiss), and U.S. Pat. No. 3,883,577 (Rabizzoni et al.) describe processes related to removing free isocyanate monomers from prepolymers by solvent extraction techniques. It is also possible to distill an isocyanate prepolymer to remove the unreacted diisocyanate according to U.S. Pat. No. 4,385,171 (Schnabel et al.). It is said to be necessary to use a compound that is only partially miscible with the prepolymer and that has a higher boiling point than that of the diisocyanate to be removed. U.S. Pat. No. 3,183,112 (Gemassmer), U.S. Pat. No. 4,683,279 (Milligan et al.), U.S. Pat. No. 5,051,152 (Siuta et al.), and U.S. Pat. No. 5,202,001 (Starner et al.) describe the use of falling film and/or wiped film evaporation. According to U.S. Pat. No. 5,502,001 (Okamoto), the residual TDI content can be reduced to less than 0.1 weight percent by passing the prepolymer at ˜100° C. through a wiped film evaporator, while adding an inert gas, especially nitrogen, to the distillation process to sweep out the TDI. The purification method descriptions of all of these references are incorporated herein by reference.

In a preferred purification method, unreacted preferably monomeric polyisocyanates can be quenched with an amine (preferably, a secondary amine; more preferably, a monofunctional secondary amine) or an alcohol (for example, an arylalkyl alcohol), preferably in the presence of a tertiary amine catalyst (such as, for example, triethylamine) or an alkoxysilane bearing a functional group that is reactive to isocyanate groups (for example, an amine). The unreacted polyisocyanates are more preferably reacted with an arylalkyl alcohol, such as benzyl alcohol, used with a tertiary amine. The unreacted polyisocyanates are most preferably reacted with an arylalkyl alcohol, such as benzyl alcohol, used in conjunction with an alkoxysilane bearing one secondary amino group. The unreacted polyisocyanates can be quenched without substantially affecting the terminal isocyanate groups of the prepolymer.

Examples of amines that are suitable for use in such a purification method include N-alkyl aniline (for example, N-methyl or N-ethyl aniline and its derivatives), diisopropylamine, dicyclohexylamine, dibenzylamine, diethylhexylamine, and the like, and mixtures thereof.

Examples of suitable alcohols include arylalkyl alcohols (for example, benzyl alcohol and alkyl-substituted derivatives thereof); free-radically polymerizable, hydroxyl-functional monomers; and the like; and mixtures thereof.

Examples of suitable silanes include DYNASYLAN 1189 (N-(n-butyl)-aminopropyltrimethoxysilane available from Degussa Corporation, NJ, USA), DYNASYLAN 1110 (N-methyl-3-aminopropyltrimethoxysilane available from Degussa Corporation, NJ, USA), SILQUEST A-1170 (bis(trimethoxysilylpropyl)amine available from Osi Specialties, Crompton Corporation, USA), SILQUEST Y-9669 (N-phenyl)-gamma-aminopropyltrimethoxysilane available from Osi Specialties, Crompton Corporation, USA), and the like, and mixtures thereof.

When alcohols are used to quench the unreacted polyisocyanates, the application of heat can be used to reduce the reaction time. Reactions with amines can generally be conducted, however, at ambient temperature for a relatively shorter period of time.

The amount of unreacted monomeric polyisocyanate present in the reaction mixture comprising the prepolymer following the reaction with the amine, alcohol, or silane is most preferably 0, but preferably can range up to about 0.7 weight percent, more preferably up to about 0.5 weight percent.

A preferred method of purifying the prepolymer is by the method of U.S. Pat. No. 6,664,414 (Tong et al.), the disclosure of which is incorporated herein by reference.

Polymers Bearing Isocyanate-Reactive Groups

Isocyanate-reactive polymers suitable for use in the method of the invention include those which bear active hydrogen-containing groups (for example, amino, thio (that is, mercapto), carboxyl, and/or hydroxyl groups). Such polymers include, for example, polycarbonates, polyalkadienes, polyethers, polyesters, polyvinyl aromatics, polyacrylics, polyvinyl esters, and the like, and combinations thereof (for example, those having an equivalent weight in the range of about 250 to about 10,000; preferably, from about 400 to about 7,500; more preferably, from about 500 to about 5,000) having an average reactive group functionality of at least about 2. Such functional polymers can be prepared by known methods, and a number are commercially available. Liquids are generally preferred, as are polymers that exhibit relatively low hydrophilicity.

The groups that are reactive to isocyanate groups are preferably hydroxyl (alcohol), primary or secondary amino, and/or carboxyl groups (more preferably, hydroxyl and/or primary or secondary amino groups; most preferably, primary or secondary amino groups), and mixtures thereof. Preferably, the polymer has an average reactive group functionality of at least about 2 (preferably, about 2 to about 20; more preferably, about 2 to about 5).

Representative examples of polymers that are useful (when functionalized in the foregoing manner) include aliphatic polycarbonates such as aliphatic polycarbonate diols; polyethers such as polyethylene glycol, polypropylene glycol, polybutylene glycol, and polytetrahydrofuran; polyvinyl aromatics such as polystyrene; polyvinyl esters such as polyvinyl acetate; polyacrylics such as hydroxyl-terminated polyacrylics and polyacrylics bearing pendant hydroxyl groups; polyesters such as polycaprolactones, polybutylene adipate, polydiethylene adipate, poly(3-methyl-1,5-pentane) adipate, and poly(neopentyl/1,6-hexane) adipate; and mixtures thereof.

The polymer is preferably hydrophobic in nature to reduce or prevent hydrolysis of its polymeric backbone. Normally, for example, adipic acid-based polyester polyols are more resistant to hydrolysis than phthalate-based polyester polyols. Polyols based on polycarbonate or dimer acid diol generally have higher hydrolytic resistance than polyester-based polyols.

Polycarbonates, polyethers, and polyesters are generally preferred, with polyethers being more preferred. Most preferred are polyethers that exhibit relatively low hydrophilicity (for example, polyethers having fewer than half (more preferably, fewer than one-third; most preferably, fewer than one-fourth) of the total number of ether units being ethyleneoxy units).

Polymerizable Reactive Diluent

Suitable reactive diluents for use in the method of the invention include those that are polymerizable (for example, acrylates, methacrylates, and epoxides). Preferably, the reactive diluent is a free-radically polymerizable monomer (for example, ethylenically-unsaturated monomers such as acrylates, methacrylates, styrene, vinyl acetate, and the like, and mixtures thereof). Preferred monomers include acryloyl- and methacryloyl-functional monomers (hereinafter designated jointly as (meth)acryloyl-functional monomers) such as, for example, alkyl(meth)acrylates, aryloxyalkyl(meth)acrylates, hydroxyalkyl(meth)acrylates, and combinations thereof; more preferably (meth)acryloyl-functional monomers of low odor, for example, having a molecular weight of at least about 150 and/or a vapor pressure of less than about 43 mbar at 20° C. (most preferably less than about 10 mbar at 20° C.). Methacrylates can be preferred over acrylates due to lower volatility.

Representative examples of suitable monomers include methyl acrylate, ethyl acrylate, n-butyl acrylate, isobutyl acrylate, t-butyl acrylate, ethyl methacrylate, butyl methacrylate, ethyltriglycol methacrylate, isobornyl acrylate, isobornyl methacrylate, 2-(((butylamino)carbonyl)oxy)ethyl acrylate, acetoacetoxyethyl methacrylate, acetoacetoxyethyl acrylate, acetoacetoxypropyl acrylate, acetoacetoxybutyl acrylate, 2-methyl-2-(3-oxo-butyrylamino)-propyl methacrylate, 2-ethylhexyl acrylate, n-octyl acrylic acetate, decyl acrylate, lauryl acrylate, stearyl acrylate, 2-hydroxyethyl acrylate, 2-hydroxypropyl acrylate, 2-hydroxyethyl methacrylate, 2-hydroxypropyl methacrylate, β-ethoxyethyl acrylate, 2-cyanoethyl acrylate, cyclohexyl acrylate, diethyl aminoethyl acrylate, hexyl methacrylate, decyl methacrylate, tetrahydrofurfuryl methacrylate, lauryl methacrylate, stearyl methacrylate, phenylcarbitol acrylate, nonylphenyl carbitol acrylate, nonylphenoxy propyl acrylate, 2-phenoxyethyl methacrylate, 2-phenoxypropyl methacrylate, N-vinyl pyrrolidone, polycaprolactam acrylate, acryloyloxyethyl phthalate, acryloyloxy succinate, 2-ethylhexyl carbitol acrylate, ω-carboxy-polycaprolactam monoacrylate, phthalic acid monohydroxyethyl acrylate, styrene, vinyl acetate, vinyl toluene, α-methyl styrene, acrylonitrile, glycidyl methacrylate, n-methylol acrylamide-butyl ether, n-methylol acrylamide, acrylamide, dicyclopentenyloxyethyl acrylate, dicyclopentenyl acrylate, dicyclopentenyloxyethyl acrylate, and the like, and mixtures thereof.

Preferred monomers include isobornyl acrylate, isobornyl methacrylate, decyl acrylate, lauryl acrylate, stearyl acrylate, 2-hydroxyethyl methacrylate, 2-hydroxypropyl methacrylate, decyl methacrylate, tetrahydrofurfuryl methacrylate, lauryl methacrylate, stearyl methacrylate, phenylcarbitol acrylate, nonylphenyl carbitol acrylate, nonylphenoxy propyl acrylate, 2-phenoxyethyl methacrylate, 2-phenoxypropyl methacrylate, and the like, and mixtures thereof (with tetrahydrofurfuryl methacrylate, 2-hydroxyethyl methacrylate, 2-hydroxypropyl methacrylate, 2-phenoxyethyl methacrylate, and 2-phenoxypropyl methacrylate, and mixtures thereof being more preferred).

If desired, small amounts of multifunctional ethylenically unsaturated monomer(s) (compounds possessing at least two polymerizable double bonds in one molecule, for example, multifunctional acrylates or methacrylates) can be utilized to, for example, effect crosslinking. Representative examples of such multifunctional monomers include ethylene glycol diacrylate; 1,2-propylene glycol diacrylate; 1,3-butylene glycol diacrylate; 1,6-hexanediol diacrylate; neopentylglycol diacrylate; trimethylolpropane triacrylate; polyoxyalkylene glycol diacrylates such as dipropylene glycol diacrylate, triethylene glycol diacrylates, tetraethylene glycol diacrylates, polyethylene glycol diacrylate; ethylene glycol dimethacrylate; 1,2-propylene glycol dimethacrylate; 1,3-butylene glycol dimethacrylate; 1,6-hexanediol dimethacrylate; neopentylglycol dimethacrylate; bisphenol-A-dimethacrylate; diurethane dimethacrylate; trimethylolpropane trimethacrylate; polyoxyalkylene glycol dimethacrylates such as dipropylene glycol dimethacrylate, triethylene glycol dimethacrylates, tetraethylene glycol dimethacrylates, polyethylene glycol dimethacrylate; N,N-methylene-bis-methacrylamide; diallyl phthalate; triallyl phthalate; triallyl cyanurate; triallyl isocyanurate; allyl acrylate; allyl methacrylate; diallyl fumarate; diallyl isophthalate; diallyl tetrabromophthalate; ditrimethylolpropane tetraacrylate; dipentaerythritol pentaacrylate; and the like; and mixtures thereof.

Preparation and Use of Liner

In carrying out the method of the invention, components (a), (b), and (c) (the isocyanate-functional prepolymer, isocyanate-reactive polymer, and polymerizable reactive diluent, respectively) can be applied to a surface (preferably, in an order and manner of combination that does not permit the premature reaction of one or more of the components) and the resulting mixture allowed to react to form a liner comprising the product of reaction of the components. (Alternatively, but less preferably, intermediates that are capable of reaction to form one or more of the components (or to form the final product) can be applied to the surface, or the liner can be preformed and then applied to the surface.)

Generally, the weight ratio of prepolymer (component (a)) to polymer (component (b)) can be in the range of about 10:1 to about 1:10, and the ratio of the combined weights of components (a) and (b) to the weight of polymerizable reactive diluent (component (c)) can be in the range of about 10:1 to about 1:10. Preferably, component (a) and/or component (b) can be dissolved in component (c). At least one of component (a) and component (b) preferably has an average reactive group functionality greater than about 2.

Preferably, the liner composition further comprises an initiator (more preferably, an initiator and an accelerator), so that initiating species can be relatively rapidly generated. This enhances the “fast set” or “quick strength development” characteristics that are often desirable in containment applications. Such characteristics can be difficult to achieve by relying solely on autoxidation (in which the rate of polymerization can be limited by the rate of oxygen penetration into the composition, etc.).

Although the resulting liner can be cured by exposure to ultraviolet (if the composition is only lightly filled) or electron beam radiation, thermal curing is generally preferred. If radiation curing is utilized, one or more photoinitiators, for example, benzophenone can be added, if necessary or desired, for example, in amounts ranging from about 0.05 to about 5 weight percent (based upon the total weight of all liner components). Representative examples of suitable photoinitiators include 2,2-dimethoxy-1,2-diphenylethane-1-one, 2-methyl-1-[4-(methylthio)phenyl]-2-morpholinopropanone-1,benzophenone, and the like, and mixtures thereof.

Preferably, however, a curing system comprising a thermally-activatable initiator (and, more preferably, also an accelerator) is utilized (for example, in amounts of from about 0.01 or 0.5 to about 5 or 10 weight percent of each, based upon the total weight of all liner components). Useful thermally-activatable initiators include organic peroxides, for example, diacyl peroxides, dialkyl peroxides, hydroperoxides, ketone peroxides, and the like, and mixtures thereof.

The accelerator of the curing system, if an accelerator is used, is generally substantially non-reactive to isocyanate and functions to decompose the initiator through, for example, a redox reaction, thereby facilitating the generation of active radicals. (Alternatively, heat and pressure can be utilized to accelerate reaction.) Useful accelerators include metal salts, for example, cobalt naphthenate and vanadium octoate; mercaptans, for example, glycol dimercaptoacetate; tertiary amines, for example, dimethyl-p-toluidine, diisopropoxy-p-toluidine, diethyl-p-toluidine, dimethyl aniline, and aniline butyraldehyde condensate; and the like; and mixtures thereof. Preferred accelerators are tertiary amines.

The kits of the invention can comprise two or more compositions, depending upon the nature of the components and the need or desire for component separation. The accelerator can be included in a kit composition that does not contain initiator. For example, the accelerator can be included in the kit composition that also contains the reactive diluent, with the initiator being included in a kit composition that preferably does not contain reactive diluent. The initiator and the reactive diluent can preferably be kept in separate kit compositions and then brought together for the first time just prior to application to a surface. The prepolymer and the reactive polymer can also preferably be kept separate until just prior to application.

The resulting liner is preferably gas-tight and flexible. The liner preferably has an elongation at break (measured according to ASTM D-638-97) of from about 10 to about 1000%, more preferably from about 30 to about 800%, even more preferably from about 50 to about 400%, most preferably from about 100 to about 300%. The liner is, preferably, a cross-linked mass having a high degree of flexibility. Preferably, the liner does not significantly swell upon contact with water.

In addition to flexibility, the liner exhibits toughness. Preferably, the liner exhibits a 4-hour Tensile Strength of at least about 1 MPa (more preferably, at least about 2 MPa; even more preferably, at least about 3 MPa; most preferably, at least about 4 MPa).

The liners produced according to the method of the invention can be used as load-bearable coatings to support, for example, rock surfaces in a mine. For such applications, the liners are preferably thick (at least about 0.5 mm; preferably, up to about 6 mm or even 10 mm or more) when cured completely.

Other additive ingredients can be included in the liner. For example, viscosity modifiers can be included to increase or decrease the viscosity, depending on the desired application technique. Fungicides can be added to prolong the life of the liner and to prevent attack by various fungi. Other active ingredients can be added for various purposes, such as substances to prevent encroachment of plant roots, and the like. Other additives that can be included in the liner, include, without limitation, rheological additives, emulsifiers, plasticizers, fillers, fire retardants, smoke retardants, defoamers, and coloring agents. Care should be exercised in choosing fillers and other additives to avoid any materials that will have a deleterious effect on the viscosity, the reaction time, the stability of the liner being prepared, and the mechanical strength of the resulting liner.

The additional filler materials that can be included in the liner can provide a more shrink-resistant, substantially incompressible, and fire retardant liner. Any of a number of filler compositions can be effective. Useful fillers include particulate filler material having a particle size of less than about 500 microns, preferably about 1 to 50 microns, and a specific gravity in the range of about 0.1 to 4.0, preferably about 0.5 to 3.0. The filler content of the cured liner can be as much as about 10 parts filler per 100 parts by weight cured liner, preferably about 5 parts to about 10 parts per 100.

Examples of useful fillers include expandable graphite (for example, graphite that expands upon application of heat) such as GRAFGUARD 220-80B or GRAFGUARD 160-150B (Graftech, Ohio, USA); silica such as quartz, glass beads, glass bubbles, and glass fibers; silicates such as talc, clays, (montmorillonite) feldspar, mica, calcium silicate, calcium metasilicate, sodium aluminosilicate, and sodium silicate; metal sulfates such as calcium sulfate, barium sulfate, sodium sulfate, aluminum sodium sulfate, and aluminum sulfate; gypsum; vermiculite; wood flour; aluminum trihydrate; carbon black; aluminum oxide; titanium dioxide; cryolite; chiolite; and metal sulfites such as calcium sulfite. Preferred fillers include expandable graphite, feldspar, and quartz. The filler is most preferably expandable graphite. The amount of filler added to the liner can preferably be chosen so that there is no significant effect on elongation or tensile strength of the resulting liner. Such amounts can be determined by routine investigation.

When filler is utilized, the resulting liner can also be fire retardant (and, if expandable graphite is the filler, can exhibit some self-extinguishment characteristics). For some applications, at least some preferred embodiments of the liner preferably can meet the fire retardant specifications of CAN/ULC-S102-M88 or ASTM E-84. These tests determine burn rate and the amount of smoke generation.

The starting components of the liner are preferably mixed immediately before being applied to a non-trafficable surface comprising or consisting essentially of at least one inorganic mineral other than a metal or a glass (preferably, a non-trafficable surface comprising or consisting essentially of at least one material selected from the group consisting of rock, stone, concrete, brick, stucco, and the like, and combinations thereof; more preferably, the group consisting of rock, stone, and the like, and combinations thereof; even more preferably, a surface in an excavation; most preferably, a surface in a mine).

As an example of the mixing process, the components can be pumped using positive displacement pumps and then mixed in a static mixer before being sprayed onto a surface. The mixture can then be sprayed onto a substrate with or without air pressure. The mixture can preferably be sprayed without the use of air. The efficiency of mixing depends on the length of the static mixer. Useful application equipment includes, for example, a pump manufactured by Gusmer Canada, Ontario, Canada, as Model H-20/35, having a 2-part proportioning high pressure spray system that feeds through a heated temperature controlled (for example, 50° C.) zone to an air purging impingement mixing spray head gun of, for example, type GAP (Gusmer Air Purge) also manufactured by Gusmer.

### EXAMPLES

Objects and advantages of this invention are further illustrated by the following examples, but the particular materials and amounts thereof recited in these examples, as well as other conditions and details, should not be construed to unduly limit this invention.

### Preparation of Polymer Bearing Isocyanate-reactive, Secondary Amino Groups (“Poly-SA”)

In a 100 mL flask, 40.0 g (0.1 mol) of Jeffarine™ D400 (amine-terminated poly(propylene glycol) having a molecular weight of 400; available from Huntsman, Salt Lake City, Utah) were added to 28.8 g (0.2 mol) 2-hydroxypropyl methacrylate while stirring at room temperature. The resulting reaction mixture (a colorless, clear liquid) was magnetically stirred at room temperature for 24 hours.

### Liner Preparation Procedure

Liners were prepared by mixing the Part A′ and Part B′ materials described in the numbered examples below (which were stored in separate cartridges) using an air-powered dispensing gun (3M™ EPX™ Applicator, available from 3M Company, St. Paul, Minn.) and an 18-element static mixer. The resulting mixture was injected into a poly(tetrafluoroethylene)-lined, stainless steel mold to make a film of 3×50×200 mm.

### Example 1

Part A′ was a mixture of 105 g of Part B of 3M™ Scotch-Weld™ Low Odor Acrylic Adhesive DP810 (containing no initiator; available from 3M Company, St. Paul, Minn.) and 7 g of Poly-SA. Part B′ was a mixture of 28 g of a trifunctional isocyanate prepolymer (a toluene diisocyanate/polyethylene oxide/polypropylene oxide (TDI/PEO/PPO) polyether prepolymer having a molecular weight of 5000, an equivalent weight of 1700, and an ethylene oxide to propylene oxide ratio of 70:30) and 1.05 g of cumene hydroperoxide (Acros Organics, Morris Plains, N.J.). The ratio of A′:B′ was 4:1. After mixing Parts A′ and B′, the resulting mixture gelled in less than 1 minute and was used to form a film. The tensile and elongation properties of a dogbone-shaped sample (0.635 cm wide) of the resulting film were tested one hour after mixing, essentially according to test method ASTM D-638-97 (American Society for Testing and Materials, West Conshohocken, Pa.) using a gauge separation of 5.08 cm (2 inches) and a separation rate of 20 cm (7.87 inches) per minute. The results are shown in Table 1 below.

### Example 2

Part A′ was a mixture of 102 g of Part B of 3M™ Scotch-Weld™ Low Odor Acrylic Adhesive DP810 (containing no initiator; available from 3M Company, St. Paul, Minn.) and 9 g of Poly-SA. Part B′ was a mixture of 35 g of the trifunctional isocyanate prepolymer described in Example 1 and 1.02 g of cumene hydroperoxide. The ratio of A′:B′ was 3:1. After mixing Parts A′ and B′, the resulting mixture gelled in less than 1 minute and was used to form a film. The tensile and elongation properties of a dogbone-shaped sample (0.635 cm wide) of the resulting film were tested one hour after mixing, essentially according to test method ASTM D-638-97 using a gauge separation of 2 inches (5.08 cm) and a separation rate of 20 cm (7.87 inches) per minute. The results are shown in Table 1 below.

TABLE 1

| | Tensile Strength | Tensile Strength | Elongation |
|---|---|---|---|
| Example | at Break | at Yield | at Break |
| No. | (MPa) | (MPa) | (%) |
| 1 | 9.95 | 8.70 | 33.75 |
| 2 | 7.19 | 4.70 | 101 |

The referenced descriptions contained in the patents, patent documents, and publications cited herein are incorporated by reference in their entirety as if each were individually incorporated. Various unforeseeable modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

We claim:

1. A method comprising providing a liner to at least a portion of at least one surface, said liner comprising the product of reaction of
(a) at least one prepolymer bearing isocyanate groups;
(b) at least one polymer bearing isocyanate-reactive groups; and
(c) at least one polymerizable reactive diluent;
wherein said surface comprises at least one inorganic mineral other than a metal or a glass, with the proviso that said surface is a surface other than a trafficable surface.

2. The method of claim 1, wherein said surface comprises at least one material selected from the group consisting of rock, stone, concrete, brick, stucco, and combinations thereof.

3. The method of claim 2, wherein said surface comprises at least one material selected from the group consisting of rock, stone, and combinations thereof.

4. The method of claim 1, wherein said surface is a surface in an excavation.

5. The method of claim 1, wherein said surface is a surface in a mine.

6. The method of claim 1, wherein said prepolymer is formed by reacting at least one polyol with at least one polyisocyanate to form a urethane-containing polymer bearing isocyanate groups.

7. The method of claim 6, wherein said urethane-containing polymer bearing isocyanate groups is at least partially purified by removing unreacted polyisocyanate or by quenching unreacted polyisocyanate with a compound that is reactive to isocyanate groups.

8. The method of claim 6, wherein said polyol is selected from the group consisting of polyester, polyether, polycarbonate, polyether polyester, and acrylic polyols, and mixtures thereof.

9. The method of claim 6, wherein said polyisocyanate is an aromatic polyisocyanate.

10. The method of claim 6, wherein said polyisocyanate is selected from the group consisting of tolylene diisocyanate (TDI), hexamethylene diisocyanate (BDI), methylene diphenyl isocyanate (MDI), xylene diisocyanate (XDI), and mixtures thereof.

11. The method of claim 1, wherein said polymer bearing isocyanate-reactive groups is selected from the group consisting of polycarbonates, polyethers, polyvinyl aromatics, polyvinyl esters, polyacrylics, polyesters, and combinations thereof, bearing active hydrogen-containing groups.

12. The method of claim 11, wherein said active hydrogen-containing groups are selected from the group consisting of amino groups, thio groups, carboxyl groups, hydroxyl groups, and mixtures thereof.

13. The method of claim 12, wherein said active hydrogen-containing groups are selected from the group consisting of amino groups, hydroxyl groups, and mixtures thereof.

14. The method of claim 1, wherein said reactive diluent is a free-radically polymerizable monomer.

15. The method of claim 14 wherein said free-radically polymerizable monomer is selected from the group consisting of acryloyl-functional monomers, methacryloyl-functional monomers, and mixtures thereof.

16. The method of claim 1, wherein said liner further comprises expandable graphite.

17. The method of claim 1, wherein said liner exhibits a 4-hour Tensile Strength of at least about 1 MPa.

18. The method of claim 1, wherein said liner exhibits an elongation at break of at least about 10 percent.

19. The method of claim 1, wherein said liner has a thickness of at least about 0.5 mm.

20. A method comprising
(a) applying to at least a portion of at least one surface that comprises at least one material selected from the group consisting of rock, stone, concrete, brick, stucco, and combinations thereof
(1) at least one prepolymer bearing isocyanate groups, said prepolymer being formed by reacting at least one polyol with at least one aromatic polyisocyanate to form a urethane-containing polymer bearing isocyanate groups, said urethane-containing polymer bearing isocyanate groups being at least partially purified by removing unreacted aromatic polyisocyanate or by quenching unreacted aromatic polyisocyanate with a compound that is reactive to isocyanate groups;
(2) at least one polymer bearing isocyanate-reactive groups, said polymer bearing isocyanate-reactive groups being selected from the group consisting of polycarbonates, polyethers, polyesters, and combinations thereof bearing active hydrogen-containing groups selected from the group consisting of hydroxyl groups, amino groups, and mixtures thereof; and
(3) at least one free-radically polymerizable monomer; and
(b) allowing the applied components to react to form a liner comprising the reaction product of said applied components;
wherein said surface is a surface other than a trafficable surface.

21. The method of claim 20, wherein said surface comprises at least one material selected from the group consisting of rock, stone, and combinations thereof.

22. The method of claim 20, wherein said surface is a surface in an excavation.

23. The method of claim 20, wherein said surface is a surface in a mine.

24. The method of claim 20, wherein said polyol is a polyether polyol.

25. The method of claim 20, wherein said aromatic polyisocyanate is tolylene diisocyanate.

26. The method of claim 20, wherein said polymer bearing isocyanate-reactive groups is a polyether.

27. The method of claim 20, wherein said active-hydrogen-containing groups are primary or secondary amino groups.

28. The method of claim 20, wherein said free-radically polymerizable monomer is selected from the group consisting of acryloyl-functional monomers, methacryloyl-functional monomers, and mixtures thereof.

29. The method of claim 20, wherein said liner exhibits a 4-hour Tensile Strength of at least about 1 MPa, an elongation at break of at least about 10 percent, and a thickness of at least about 0.5 mm.

30. A liner comprising the product of reaction of
(a) at least one prepolymer bearing isocyanate groups;
(b) at least one polymer bearing isocyanate-reactive groups;
(c) at least one polymerizable reactive diluent; and
(d) expandable graphite.

31. A mine that is at least partially lined with a liner prepared by the method of claim 1.

32. A mine that is at least partially lined with a liner prepared by the method of claim 20.

33. A mine that is at least partially lined with the liner of claim 30.

34. A building structure having at least one non-trafficable surface that is at least partially lined with a liner prepared by the method of claim 1.

35. A building structure having at least one non-trafficable surface that is at least partially lined with a liner prepared by the method of claim 20.

36. A building structure having at least one non-trafficable surface that is at least partially lined with the liner of claim 30.

37. A kit comprising
(a) a first composition comprising
(1) at least one prepolymer bearing isocyanate groups, and
(2) at least one polymerizable reactive diluent that contains essentially no isocyanate-reactive groups; and
(b) a second composition comprising at least one polymer bearing isocyanate-reactive groups, which, when combined with said first composition, reacts to form a material suitable for use as a liner;
wherein said kit further comprises expandable graphite.

38. A kit comprising
(a) a first composition comprising
(1) at least one polymer bearing isocyanate-reactive groups, and
(2) at least one polymerizable reactive diluent that contains essentially no isocyanate groups; and
(b) a second composition comprising at least one prepolymer bearing isocyanate groups, which, when combined with said first composition, reacts to form a material suitable for use as a liner;
wherein said kit further comprises expandable graphite.
